(19) United States
(12) Patent Application Publication
(10) Pub. No.: US 2017/0213576 A1
(43) Pub. Date: Jul. 27, 2017

(54) Live Comics Capturing Camera

(71) Applicants: Artur Nugumanov, pleasanton, CA (US); Vasilii Telezhnikov, Moscow (RU); Vadim Asadov, San Diego, CA (US)

(72) Inventors: Artur Nugumanov, pleasanton, CA (US); Vasilii Telezhnikov, Moscow (RU); Vadim Asadov, San Diego, CA (US)

(21) Appl. No.: 15/411,951

(22) Filed: Jan. 20, 2017

Related U.S. Application Data
(60) Provisional application No. 62/286,143, filed on Jan. 22, 2016.

(51) Int. Cl. G11B 27/036; H04N 5/14; G06F 17/24; G06K 9/00

(52) U.S. Cl. CPC G11B 27/036; G06K 9/00684; H04N 5/144; G06F 17/241

(57) ABSTRACT

A method of preprocessing a plurality of raw video files has the steps of a user selecting the plurality of raw video files, creating an exposure histogram for raw video files on a predetermined interval, creating a color histogram for at least one of the plurality of raw video files on a predetermined interval, determining a camera movement velocity, determining a camera trajectory, determining an image sharpness for at least one of the plurality of raw video files on a predetermined interval, and determining a raw video location based GPS information embedded into the plurality of raw video files. In an embodiment, determining a scene location comprises the steps of indexing the color histogram, indexing the raw video location based on geographic proximity, grouping the scene location based the color histogram, grouping the scene location based on the raw video location and determining a plurality of scene groupings.

### CROSS-REFERENCE TO RELATED APPLICATION(S)

The present application claims priority to U.S. Provisional Patent Application No. 62/286,143 filed on Jan. 22, 2016, entitled “AUTOMATIC LIVE COMICS CAPTURING CAMERA APPARATUS AND METHODS” the entire disclosure of which is incorporated by reference herein.

### BACKGROUND OF THE INVENTION

1. Field of Invention

The present invention relates to the field of converting audio and video recorded media to a comic format.

2. Description of Related Art

Digital photos, audio and video are in common use for recording and online sharing of our daily life stories. Millions of photos and videos are shared on the Internet daily, through all sorts of contexts. For the most part, the video and audio is unaltered except for the order of the video scenes within a video, and sound in the background.

For years, tools have existed for modifying images to create effects, from changing the lighting, hue and coloration, to converting an image to look like a painting or a cartoon. Where a cartoon movie is created, a number of still images may be appended to play in sequence and provide the illusion of movement. Generally, at least 24 frames per second provides an illusion of smooth movement.

Comic books have been popular for years as describing a storyline with drawings and text boxes, which is generally viewed as more engaging than mere text or photos on their own. In the prior art, comic effects modify a photo to appear as a drawings, by applying brushstrokes and other effects, and reducing the level of detail, perhaps pixellating the colors to appear like ink on newsprint or comic book paper. Captions may be added manually to such drawings in order to describe the action in the photo or move the action along.

In the case of converted digital photos, they are generally just digitized versions of analog pictures and videos, which were never created with new Internet and social media era demands in mind, and are not easily manipulated using digital means.

There are two currently used methods for resolving this problem: 1) manual storytelling with video, photo collaging and text, which unfortunately requires skill and time from the user to create manually, and 2) automated video editing software, which still has all the limitations of video format and inserts the video into a preformed template, that will work correctly only for specific cases (e.g. GoPro action video music clip auto editing). The current solutions generally do not analyze the content of the video and have no way of identifying the more interesting action portions and differentiating them from the slower parts, to provide a more engaging content.

Therefore there is a need for a format, method and apparatus designed top to bottom to cover modern social sharing demands: ease of creation, laconic and fast storytelling, ability to share on popular social networks. Ideally, the apparatus would be a new type of smart capture and post-processing device which created to record stories in “live comics” format, like photo camera would record photos or video camera would record videos, so as to tell the stories within the day to day life of the user.

### SUMMARY OF THE INVENTION

New online media format designed specifically for modern social media needs. The format which is more laconic than video and much more informative than photo (illustrated in FIG. 3 and described above). The user interface of the device is similar to regular video camera, however the camera produces result in new comic-like format. Multiple new sensors and signal processing techniques are utilized, so the camera can arrange visual data in new format.

Also described are method aspects of drawing comics-style speech bubbles to speaking person/face in the video scene using Haar-Cascade (or DNN based) face localization techniques along with speech recognition, voice detection and facial feature tracking (mouth movement), and an aspect of a method to select key storytelling frames based on scoring system. In one aspect of the method will calculate scores based on frames phase correlation, face tracking, image histogram, image classification, movement classification along with sound classification and gyroscope trajectory classification then combine those based on weights trained experimentally to produce the best possible result. In an embodiment, an aspect of the method to apply proper visual effect and/or comic-like sticker based on combined data from image and sound classifiers along with basic natural language processing techniques.

In an embodiment, a method for automatic video annotation achieved through video and audio post processing, separating video to multiple scenes (frames) using algorithms described above. This will allow new more time efficient way of watching video, where less informative parts will be narrated through set of pictures and comic captions/bubbles and more informative parts would be accessed through single click. Motion classification based on Deep Learning Network which is learned from pre-rendered realistic 3D animations from different angles and different textures may also be used.

A method for creating comic stories comprising the steps of preprocessing a plurality of raw video files, determining a scene location, indexing a plurality of scenes, categorizing motions depicted in the plurality of scenes, and building a comic story.

In an embodiment, preprocessing a plurality of raw video files comprises the steps of a user selecting the plurality of raw video files, creating an exposure histogram for at least one of the plurality of raw video files on a predetermined interval, creating a color histogram for at least one of the plurality of raw video files on a predetermined interval, determining a camera movement velocity, determining a camera trajectory, determining an image sharpness for at least one of the plurality of raw video files on a predetermined interval, and determining a raw video location based GPS information embedded into the plurality of raw video files.

In an embodiment, determining a scene location comprises the steps of indexing the color histogram, indexing the raw video location based on geographic proximity, grouping the scene location based the color histogram, grouping the scene location based on the raw video location and determining a plurality of scene groupings based on the color histogram and the geographic proximity using a predetermined schedule.

In an embodiment, indexing a plurality of scenes comprises the steps of detecting inanimate objects depicted in the plurality of scenes, detecting animate objects depicted in the plurality of scenes, scoring inanimate objects depicted in the plurality of scenes based on a predetermined schedule, and scoring animate objects depicted in the plurality of scenes based on a predetermined schedule.

In one embodiment, categorizing motions depicted in the plurality of scenes comprises the steps of detecting motions depicted in the plurality of scenes based on a predetermined schedule, categorizing motions depicted in the plurality of scenes based the object creating the motion, and categorizing motions depicted in the plurality of scenes based on type of motion detected.

In a further embodiment, wherein building a comic story comprises the steps of selecting a plurality of final scenes, applying a plurality of scene annotations, and outputting the plurality of final scenes in a publishable format.

In an embodiment, selecting a plurality of final scenes comprises the steps of scoring the plurality of scene groupings based on a predetermined schedule, scoring motions depicted in the plurality of scenes based on a predetermined schedule, determining a scene score for the plurality of scene groupings based on a predetermined schedule, and determining the plurality of final scenes based on scoring and a predetermined schedule.

In an embodiment, applying a plurality of scene annotations comprises the steps of detecting words within the plurality of scene groupings, and adding graphic representations of words within the plurality of scene groupings based on a predetermined schedule to the plurality of final scenes.

In an embodiment, outputting the plurality of scenes in a publishable format comprises compiling the plurality of final scenes, ordering the plurality of final scenes based on the temporal order of the plurality of raw video files, and outputting the plurality of scenes in a user-defined format.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is an embodiment of a device for generating live comic output, according to an embodiment of the present invention;

FIG. 2 is a flowchart view of the input means to the system and the handling procedures therefor, according to an embodiment of the present invention;

FIG. 3 is a screenshot of the live comic output by the system after processing, according to an embodiment of the present invention;

FIG. 4 is a flowchart of the method of generating live comic output by the system, according to an embodiment of the present invention; and

FIG. 5 is a representation of a data structure of the live comic output by the system, according to an embodiment of the present invention.

### DETAILED DESCRIPTION OF PREFERRED EMBODIMENTS

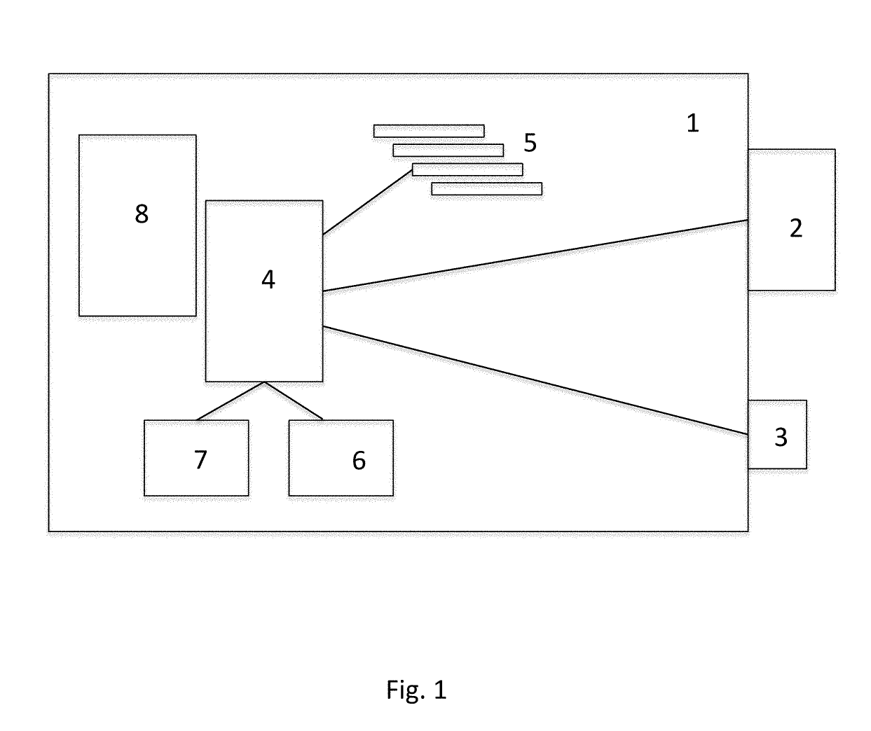

Preferred embodiments of the present invention and their advantages may be understood by referring to FIGS. 1-5, wherein like reference numerals refer to like elements.

With reference to FIG. 1, a camera, particularly mobile phone camera, may be used for automatic live comics capturing. In an embodiment, a stand-alone comics video capture device 1 may be used. A stand-alone camera 1 may be useful for capturing audio and video for live comics processing, and would comprise at least a microphone 3, photo and video recording chip and lens 2, memory storage 5, and a processing chip 4 to process the audio and video content. In an embodiment, the camera may also have a GPS receiver 7 to determine and record location, and gyroscope 6 to determine and record movement. In one embodiment, a mobile phone, preferably a smartphone, has many of these features, typically having a digital video camera 2 thereon, a microphone 3, a screen 8 for interaction with the user and for aiming the camera, a GPS unit 7, at least one accelerometer or gyroscope 6, and a processor 4 with memory 5 that is capable of running video processing software. The processor 5 may operate in conjunction with a GPU (not shown) for the video processing.

Live comics capturing is a process for converting raw video and audio data from camera and microphone, respectively, to comic-like storyboard using signal processing and classification. The images are converted to a comic-like appearance by normalizing the image, posterizing, despeckling and blurring the image. An example, wherein the images are synthesised by finding an image that simultaneously matches the content representation of the photograph and the style representation of the respective piece of art. While the global arrangement of the original photograph is preserved, the colours and local structures that compose the global scenery are provided by the artwork. Effectively, this renders the photograph in the style of the artwork, such that the appearance of the synthesised image resembles the work of art, even though it shows the same content as the photograph. Other techniques known in the art may be used on each frame to create a comic appearance. The sound is recognized into text and the text may be appended to one or more frames as a talking bubble. Alternatively, the action in the frame may be characterized and described in text below.

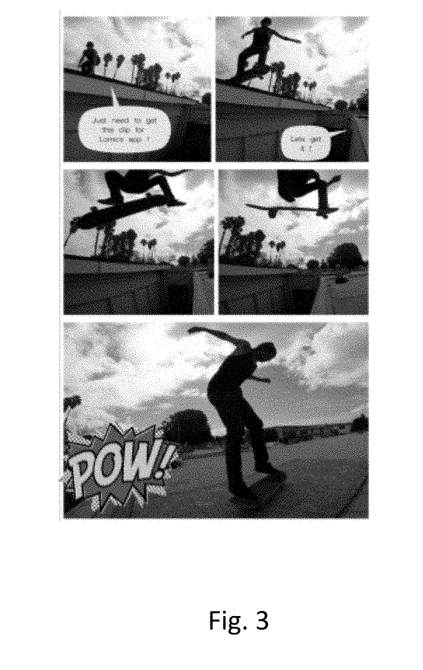

With reference to FIG. 3, an example comic is shown, wherein the tiles of the comic are ordered in a strip. Each tile shows a comic image with an optional speech bubble or text box, similar to a normal comic tile in a comic publication. In this example there are six tiles. Each tile is representative of a story scene (video snippet), which optionally plays when a user indicates the tile by tapping on it, for example, or the scene may play automatically in the series in which the tiles are arranged. When activated, the tile plays the scene with sound in a comic appearance format. Each scene is short, and the story is told through the multiple tiles and short scenes. Generally, one scene does not follow directly from the previous scene, rather the scene is related to the tile that represents it. The tile will generally be a frame from the scene. The viewer can generally understand the subject matter of the scene from the tile, and if interested, engages it.

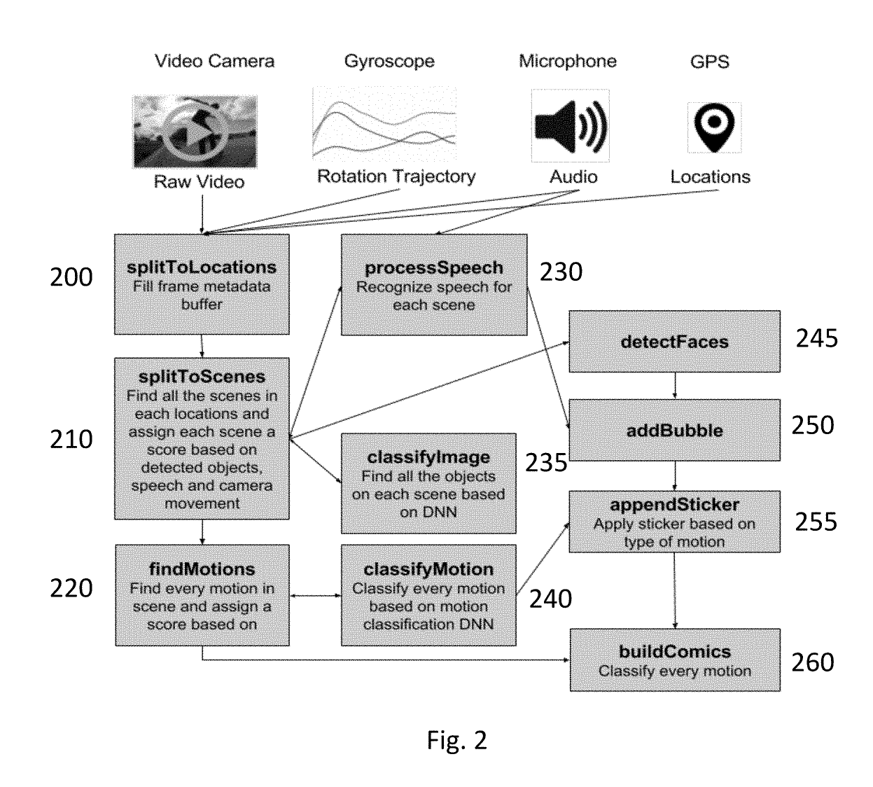

With reference to FIG. 2, proper conversion requires data from multiple sensor devices including cameras 2 (providing raw video), microphones 3 (providing audio), gyroscope 6 (providing rotational trajectory) and GPS 7 (providing location information).

The system analyzes the data from the sensors and seeking for signal interdependencies to choose and arrange key storytelling frames. The data from the gyroscope indicates periods of fast movement and periods of slower movement. The faster movement may be characterized as an action sequence, while the slower period may be a lull in the action. In an embodiment, lulls in the action may be skipped over or dealt with in a single frame.

The system analyzes each frame and detects faces and facial features, recognizes facial expression and detects speech to properly apply comic speech bubbles, visual effects and stickers. In an embodiment, the system uses the camera's built-in facial recognition algorithms to determine the location and number of faces with the frame.

With reference to FIG. 3, The format is similar to classic American comics format, such as DC's Superman ro Marvel's Spider-Man, with the following main elements (FIG. 3): key storytelling images; key storytelling episodes; speech bubbles attached to faces; captions; stickers; and comic-like frames.

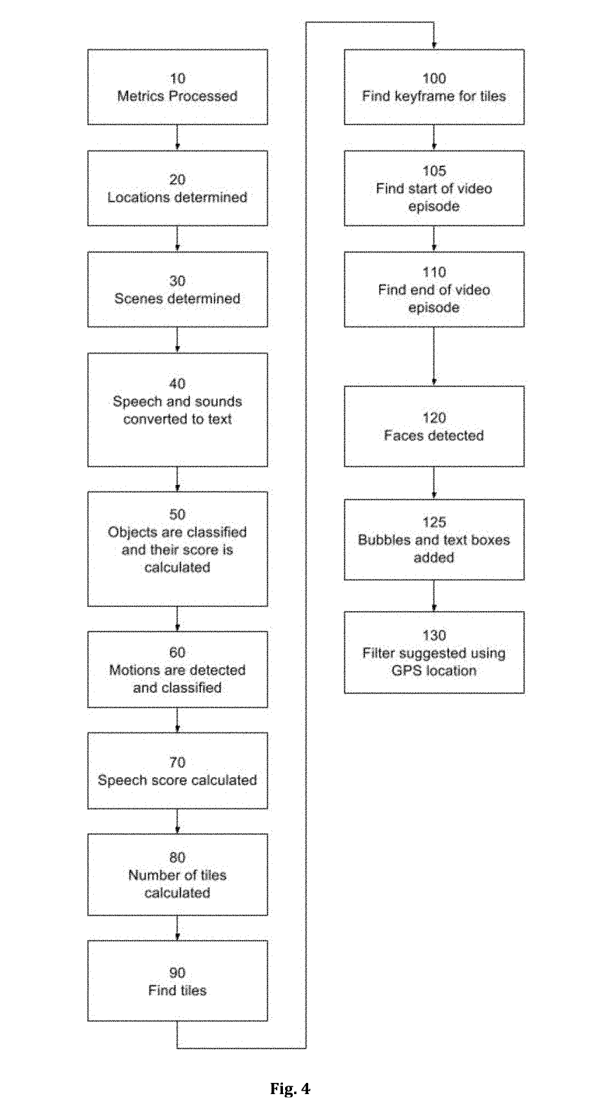

To operate properly the described device 1 has to analyze the data from multiple sensors simultaneously, including microphone 3, video 2, gyroscope 6 and GPS device 7 (see in FIG. 1). The device solves the problem of building a comic strip from video frames in several stages. The method of operation is shown in FIG. 4. In step 10, it preprocesses all the metrics needed for finding proper comic strip tiles and video episodes including histogram, camera movement velocity, camera trajectory compensated object movement, frame image sharpness, indicating movement, and GPS location (through the processVideoStream procedure, in an embodiment). In step 20, the system finds all the different locations from the video based on GPS location and color histogram (in an embodiment, using the procedure splitToLocations). In step 30, the system finds every “scene” in each location, meaning a video episode that recorded while the camera i) points in the same direction and ii) is at the same location throughout (in an embodiment, encompassed in the procedure splitToScenes). In step 40, audio signals are recognized as speech and sounds, and are converted to text. At step 50, in each scene the system detects all the objects and classifies them, and based on which objects are in the scene the score is adjusted higher or lower. For example, scenes that have animate (moving) subjects in them, such as animals/pets or people, would receive higher scores than those with inanimate subject matter, such as architecture. The objects are classified based on Deep Learning Neural Network, which is pre-learned based on images from Google and Instagram, and which learns based on feedback from the user. In step 60, the system finds and marks every motion in the scene like jumping, hand waving, smiling, running, and walking, for example. This is based on tracking video animation while compensating camera movement using phase correlation algorithm. In an embodiment, the procedure used is a findMotions procedure, and in an embodiment, the motions are classified based on a Deep Learning Neural Network that is pre-learned based on 3D-rendered people and animal motions from different angles and using different textures. In step 70, a speech score is calculated to determine the amount and value of the speech in the scene. In step 80, the number of tiles needed is calculated, And in step 90, the tiles are found by the highest velocity scene. In step 100 the keyframe is found for the tiles, and in step 105 the start of the video episode is found, and in step 110 the end of each video episode is found. In step 120, faces are detected in each scene using algorithms that are known in the art. The system may apply bubbles and/or stickers next to detected faces of humans or animals in step 125. The bubbles will be pre-filled with text recognized from the associated audio using speech recognition services known in the art. Speech bubbles may also be applied based on motions classified from the video in step 60. In step 130 a filter is suggested using the GPS location.

With reference to FIG. 2, example subroutines are described below. As an example of a procedure in step 10, processVideoStream takes the stream as an input, and for each frame, it calculates the histogram, determines the camera velocity, difference between this and the previous frame, and the sharpness of the frame, which is indicative of movement of the camera and therefore action. The GPS location is also recorded for each frame.

As an example of the procedure of step 20, splitToLocations 200 determines the different locations of the frame. For each frame, if the frame histogram has changed, or the frame GPS location has changed, then a new location is marked as started.

A further example of a procedure for step 30, splitToScenes 210 searches for the frame with velocity below start scene threshold and marks it as the scene start. After that it appends all subsequent frames to the scene before frame with velocity higher than end scene threshold is found. At this point current scene is finished and procedure starts from first step by searching frame which starts next scene.

With regard to the procedure used on findMotions 220, the system finds motions and takes the scene as an argument. It searches for the frame with difference between previous frame is more than start motion threshold and marks it as the motion start. After that it appends all subsequent frames to the motion before frame with difference from previous frame is less than end motion threshold is found. At this point current motion is finished and procedure starts from first step by searching frame which starts next motion.

The findTiles procedure determines a scene with best score and adds it to the tile list. After that procedure penalizes scenes that too close to current one in time by substructing from each scene's scores Gaussian function. The Gaussian function has its maximum at current scene's timestamp. Procedure repeats previous steps until it finds desired number of tiles.

In order to build the story of the comic strip images, in step 10 the video stream is processed and in step 20 the resulting frames are separated by geographic location using splitToLocations 200. For each location, in step 30 the procedure splitToScenes 210 to determine individual scenes with reference to the velocity of the scene. In step 40, using the procedure processSpeech 230 the speech and/or sounds of the scene are converted to text, and in step 50 the objects in the scene are classified and their score is calculated using getScoreForObjects involving all objects in the scene, wherein animate objects receive a higher value than inanimate ones. Objects score are added to the scene score. In step 60 motions are detected using findMotions and classified through classifyMotions 240. Motions scores are calculated through getScoreForMotion and added to the scene score wherein some motions such as jumping, skateboard tricks, kicking or punching are more important than other less energetic motions. In step 70, scene score also tabulated by using word count, value of words, or speech duration, using the procedure getScoreForSpeech. classifyImage 235 classifies image using deep neural network. The procedure appendSticker 255 adds stickers to comic tiles. The procedure, buildComics 260, builds comics, wherein it uses “process” procedure (steps 10-115) and finishes building the comic story (as described in steps 120, 125, and 130 steps shown in FIG. 3.

Now that the video stream is split by scenes, and each scene has a score which helps determine its importance, the number of tiles is determined in step 80 by summing the scores of all scenes' motions scores. The number of times has a cap to prevent long videos from producing too many tiles. The tiles are determined in step 90 by a findTiles procedure that takes all motions and the number of tiles as arguments.

Once the tiles are determined, out of all tiles the sharpest tile is found in step 100, and the motion start is found between frame 0 and the sharpest frame in step 105, whereas the motion end is found between the sharpest frame and the end of the scene in step 110.

The comics building procedure takes the stream as an argument, and, for each tile in the comics, at step 120 faces are detected in the tiles using detectFaces 245, and text bubbles or text boxes are added to describe what is being said, sounds or the action being viewed at step 125 using addBubble 250. In step 130, a filer is suggested according to the image/motion classification, or geographical GPS location.

With use of modern mobile sensors on a typical smartphone, such as gyroscope, camera, microphone, GPS; and advanced methods of signal processing, a new type of device is enabled for automated comic format storytelling. The format and device is designed “top to bottom” to cover modern Internet and social networks user demands, and for sharing comics of events in users' lives.

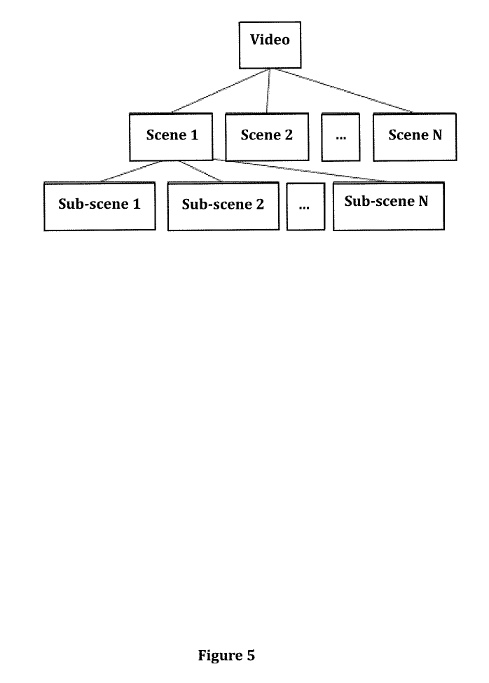

With reference for FIG. 5, a data structure for use in the method is shown, wherein the tree-like data structure is used to mark the video episodes of FIG. 3. The video processor can quickly find the most interesting parts of the scene by going down in hierarchy. For example, if we have an action movie about police and local LA gang, the scenes would be:
Scene 1: Intro on main character, his history
Scene 2: Gang history
Scene 3: Robbery scene
Scene 4: Police is trying to find the criminals
Scene 5: Gang and Police fight
Scene 6: Happy end

Each of the scene may have multiple sub-scenes, for example in Scene 5:
Sub-Scene 1: Police officer is fighting a criminal
Sub-Scene 2: Shooting scene
Sub-Scene 3: Gang running away
Sub-Scene 4: Police is chasing the gang

Now the viewer can see Scenes 1,2,3,4 in as live comic slides that are represented as static tiles until activated or dynamic tiles. However in scene 5 the viewer would like to see the action in a dynamic form, so the user selects Scene 5 and within that scene selects sub-scene 2. The rest of the scenes are also watched in live comic format. In this way, the format allows a user to get the most of the movie experience in just 10 minutes for example, instead of −2 hours.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A method for creating comic stories comprising the steps of:
a. preprocessing a plurality of raw video files;
b. determining a scene location;
c. indexing a plurality of scenes;
d. categorizing motions depicted in the plurality of scenes; and
e. building a comic story.

2. The method of claim 1, wherein preprocessing the plurality of raw video files comprises the steps of:
a. a user selecting the plurality of raw video files;
b. creating an exposure histogram for at least one of the plurality of raw video files on a predetermined interval;
c. creating a color histogram for at least one of the plurality of raw video files on a predetermined interval;
d. determining a camera movement velocity;
e. determining a camera trajectory;
f. determining an image sharpness for at least one of the plurality of raw video files on a predetermined interval; and
g. determining a raw video location based GPS information embedded into the plurality of raw video files.

3. The method of claim 2, wherein determining a scene location comprises the steps of:
a. indexing the color histogram;
b. indexing a location of the plurality of raw video files based on geographic proximity;
c. grouping the scene location based the color histogram;
d. grouping the scene location based on the raw video location; and
e. determining a plurality of scene groupings based on the color histogram and the geographic proximity using a predetermined schedule.

4. The method of claim 1, wherein indexing a plurality of scenes comprises the steps of:
a. detecting inanimate objects depicted in the plurality of scenes;
b. detecting animate objects depicted in the plurality of scenes;
c. scoring inanimate objects depicted in the plurality of scenes based on a predetermined schedule; and
d. scoring animate objects depicted in the plurality of scenes based on a predetermined schedule.

5. The method of claim 1, wherein categorizing motions depicted in the plurality of scenes comprises the steps of:
a. detecting motions depicted in the plurality of scenes based on a predetermined schedule;
b. categorizing motions depicted in the plurality of scenes based the object creating the motion; and
c. categorizing motions depicted in the plurality of scenes based on type of motion detected.

6. The method of claim 3, wherein building a comic story comprises the steps of:
a. selecting a plurality of final scenes;
b. applying a plurality of scene annotations; and
c. outputting the plurality of final scenes in a publishable format.

7. The method of claim 6, wherein selecting a plurality of final scenes comprises the steps of:
a. scoring the plurality of scene groupings based on a predetermined schedule;
b. scoring motions depicted in the plurality of scenes based on a predetermined schedule;
c. determining a scene score for the plurality of scene groupings based on a predetermined schedule; and
d. determining the plurality of final scenes based on scoring and a predetermined schedule.

8. The method of claim 7, wherein applying a plurality of scene annotations comprises the steps of:
a. detecting words within the plurality of scene groupings; and
b. adding graphic representations of words within the plurality of scene groupings based on a predetermined schedule to the plurality of final scenes.

9. The method of claim 8, wherein the step of outputting the plurality of scenes in a publishable format comprises
a. compiling the plurality of final scenes;
b. ordering the plurality of final scenes based on the temporal order of the plurality of raw video files; and
outputting the plurality of scenes in a user-defined format.
